(19) United States
(12) Patent Application Publication
(10) Pub. No.: US 2011/0114809 A1
(43) Pub. Date: May 19, 2011

(54) Mounting Bracket for Blind

(76) Inventor: Philip Ng, Thornhill (CA)

(21) Appl. No.: 12/621,731

(22) Filed: Nov. 19, 2009

(51) Int. Cl. F16M 13/00

(52) U.S. Cl. 248/309.1

(57) ABSTRACT

The invention is a fascia and mounting bracket combination for a blind having a head portion. The mounting bracket and fascia combination includes a mounting bracket having a first locking element and a fascia having a face portion and an extended leg. The extended leg has a proximal end adjacent the face portion and a distal end opposite the proximal end. The fascia and bracket combination further includes a second locking element formed on the fascia adjacent the distal end of the extended leg, the second locking element configured to mate with the first locking element. A release member is mounted to the mounting bracket adjacent the first locking element, the release member movable between a locked position wherein the release member is clear of the second locking element, and a release position wherein the release member bears against the second locking element sufficiently to disengage the second locking element from the first locking element.

### FIELD OF THE INVENTION

The invention relates generally to mounting elements for mounting a decorative fascia to the head portion of a blind.

### BACKGROUND OF THE INVENTION

Most window blinds consist of a fabric (or other) blind suspended from a head portion which is mounted adjacent the top of the window. The head portion can consist of a roller blind assembly (in the case of a roller blind) or some other similar control unit which incorporates the mechanism required to raise and lower the blind. The head portion can be unattractive, therefore a fascia is generally mounted in front of the head portion to present a more pleasant appearance. The fascia may be mounted to mounting brackets which in turn are mounted to the wall or window frame. In many cases, the head portion is also mounted to the mounting brackets making it necessary to remove the fascia in order to remove the head portion. Removing the fascia can be difficult where the head portion covers over or obscures the mounting brackets holding up the fascia. In the case of very wide blinds the problem is increased because of the awkwardness caused by the length of the fascia and head portion. Therefore, an improved mounting system for releasably mounting the fascia and head portion to a window would be advantageous.

### SUMMARY OF THE INVENTION

In accordance with one aspect of the invention, there is provided a fascia and mounting bracket combination for a blind which is simple to install and which permits the quick and easy installation and removal of the head portion. The mounting bracket and fascia combination includes a mounting bracket having a first locking element and a fascia having a face portion and an extended leg. The extended leg has a proximal end adjacent the face portion and a distal end opposite the proximal end. The fascia and bracket combination further includes a second locking element formed on the fascia adjacent the distal end of the extended leg, the second locking element configured to mate with the first locking element. A release member is mounted to the mounting bracket adjacent the first locking element, the release member movable between a locked position wherein the release member is clear of the second locking element, and a release position wherein the release member bears against the second locking element sufficiently to disengage the second locking element from the first locking element.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a cross sectional view of a mounting bracket and fascia combination made in accordance with the present invention and showing the fascia mounted to the mounting bracket.

FIG. 2 is an expanded view of portion A of FIG. 1 showing the release member in its locked position.

FIG. 3 is an expanded view as in FIG. 2 showing the release member in its unlocked position.

FIG. 3 is an isometric view of the mounting bracket and fascia combination made in accordance with the present invention.

FIG. 4 is a cross sectional view of the fascia portion of the present invention.

FIG. 5 is an isometric view of the fascia portion of the present invention.

FIG. 6 is a cross sectional view of the mounting bracket portion of the present invention.

FIG. 7 is an isometric view of the mounting bracket portion of the present invention.

FIG. 8 is a cross sectional view of portion A of FIG. 1 showing the release member in its release position.

In the drawings, like characters of reference indicate corresponding parts in the different figures.

### DETAILED DESCRIPTION OF THE PREFERRED EMBODIMENT

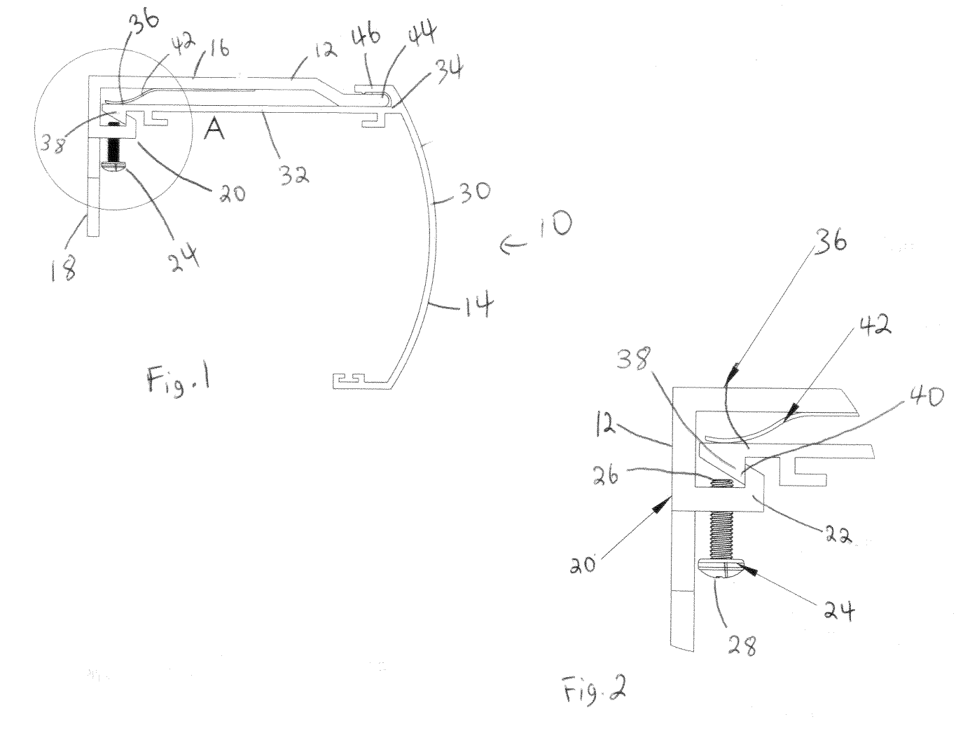

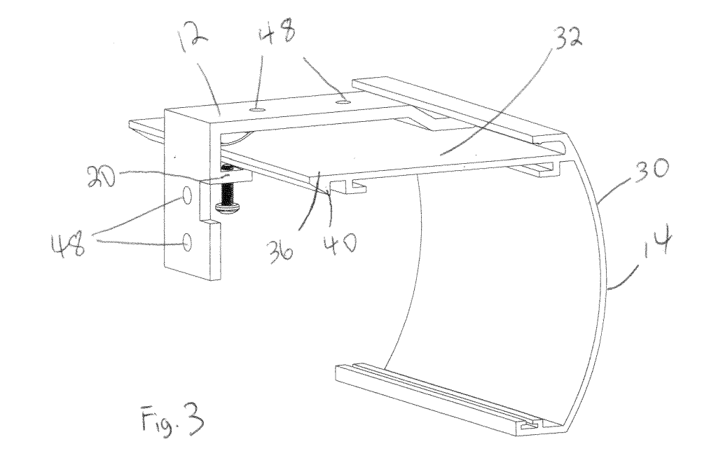

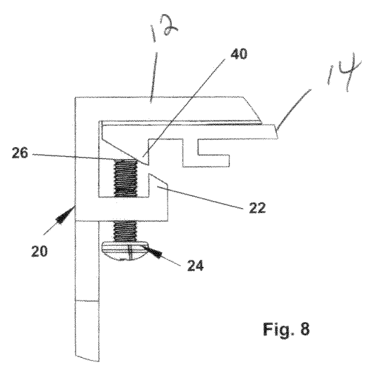

Referring firstly to FIG. 1, a fascia and mounting bracket combination made in accordance with the present invention is shown generally as item 10 and consists of mounting bracket 12 and fascia 14. Mounting bracket 12 has elongated arm portion 16 and transverse portion 18. A first locking element 20 is formed on bracket 12, preferably on transverse portion 18. Fascia 14 consists of a member having a face portion 30 and an extended leg portion 32, the leg portion having a proximal end 34 adjacent the face portion 30 and a distal end 36 opposite the proximal end. A second locking element 38 is formed on the distal end 36 of the leg portion. First locking element 20 and second locking element 38 preferably consists of hooks 22 and 40, respectively, which are configured to hook together. A release member 24 is mounted to mounting bracket 12 adjacent locking element 20. Release member 24 is movable between a locked position, as shown in FIG. 2 wherein the release member is clear of the second locking element 38 and release position wherein the release member bears against the second locking element sufficiently to disengage the second locking element from the first locking element (see FIG. 8). In the embodiment shown in the drawings, release member 24 consists of a screw having a screw head 28 and a screw end 26 opposite the screw head. Moving the release member 24 between its locked and release position simply involves turning the screw so as to urge end 26 either towards or away from locking element 38. Mounting bracket 12 is provided with a biasing spring 42 which is positioned to urge second mounting element 38 towards first mounting element 20 to prevent the second mounting element from accidentally dislodging from the first mounting element.

Elongated arm portion 16 of bracket 12 has a first mounting element 44 formed on its end which is configured to mate with a second mounting element 46 formed on facia 14 adjacent proximal end 34. Mounting elements 44 and 46 preferably form a tongue and groove connection for quick and easy mounting. The lengths of arm portion 16 and leg portion 32 are selected so that the first and second locking elements 38 and 20 engage in locking orientation when mounting elements 44 and 46 couple together.

Referring now to FIG. 3, mounting bracket 12 preferably consists of an L shaped member having apertures 48 for permitting the mounting bracket to be mounted to a wall, ceiling or window frame (not shown). Preferably, mounting bracket 12 consists of stamped steal; however, it may consist of an aluminium extrusion or even a cast metal part. Fascia 14 preferably consists of an extruded aluminium part. Extended leg portion 32 is dimensioned to be sufficiently resilient to permit the leg to deflect sufficiently to permit end 36 to move upwards and allow hook 40 to engage locking element 20.

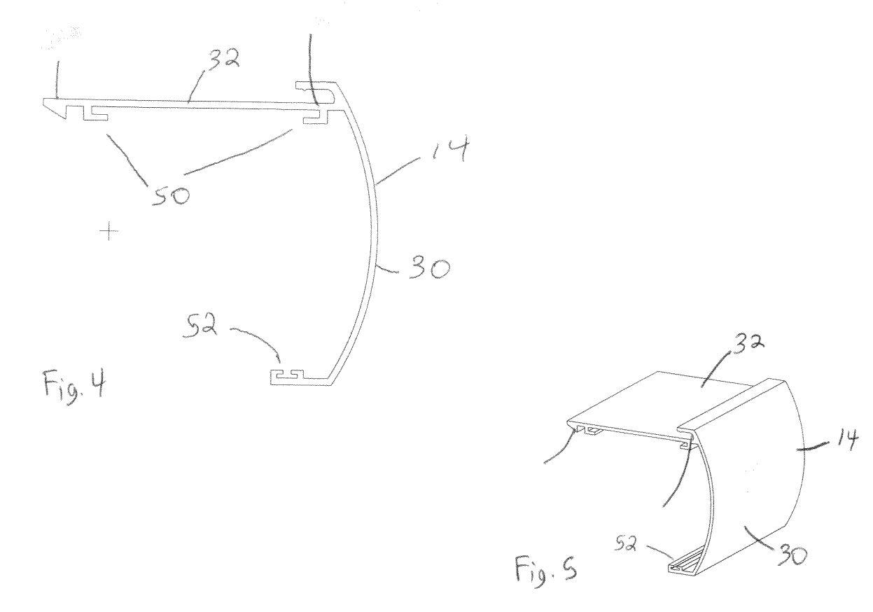

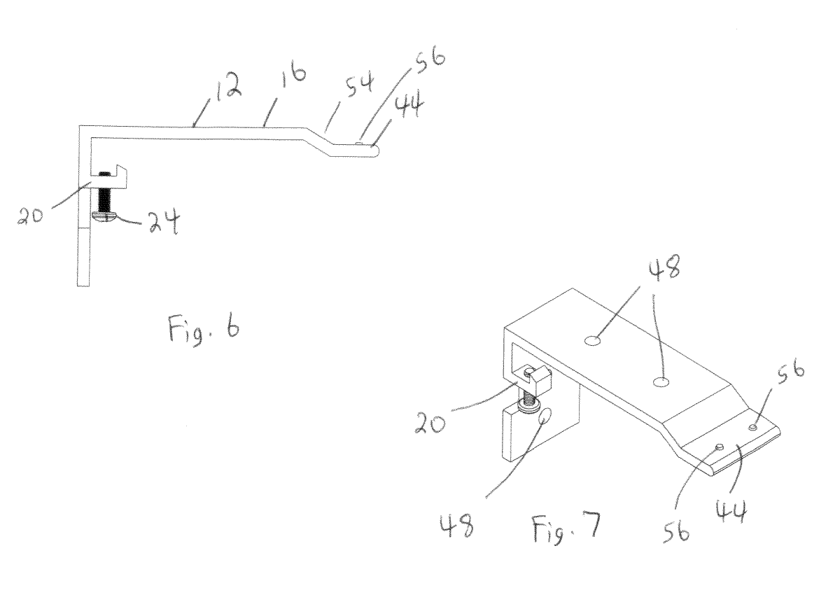

Referring now to FIGS. 4 and 5, fascia 14 is preferably a single extruded aluminium part having a decorative face 30. Extended leg portion 32 has mounting elements 50 formed on its underside to permit the head portion of a blind (not shown) to mount within facia 14. Face portion 30 has a decorative face formed thereon.

Referring now to FIGS. 6 and 7, bracket 12 preferably consists of a strong stamped steal part which is L shaped and provided with apertures 48 to permit the mounting bracket to be mounted to a wall or ceiling. Mounting element 44 forms a tongue and extends at one end of arm portion 16. A bend 54 is formed adjacent mounting element 44 to position the mounting element slightly lower than the rest of the arm portion. Bumps 56 are formed on mounting element 44 to provide a close fit when mounting element 44 is mated to mounting element 46 of the fascia 14 (see FIG. 1).

Referring now to FIG. 8, screwing release member into its release position as shown, causes end 26 to bear against hook 40 sufficiently to disengage hook 40 from hook 22 of locking element 20. This effectively unlocks the connection and permits the facia member 14 to be easily removed from bracket 12.

Referring back to FIG. 1, the present invention makes it quite easy to install and remove a blind. Several mounting brackets 12 can be first mounted to a wall, ceiling or window frame (not shown) as required. The head portion of the blind (not shown) can be mounted to facia 14. Fascia 14 can then be aligned with bracket 12 such that the end 36 of fascia 14 is pointed towards locking element 20 and mounting element 44 is pointed towards mounting element 46. The fascia is then urged towards mounting bracket with sufficient force to couple locking elements 20 and 38 together and mounting elements 44 and 46 together. The fascia is thereby quickly and easily mounted to the mounting brackets. To remove the fascia, release members 24 are then moved into their release positions (see FIG. 8) which unlocks locking elements 20 and 38 permitting the fascia to be pulled off the mounting bracket.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

I claim:

1. A fascia and mounting bracket combination for a blind, comprising:
a) a mounting bracket having a firs locking element;
b) a fascia having a face portion and an extended leg, the extended leg having a proximal end adjacent the face portion and a distal end opposite the proximal end;
c) a second locking element formed on the fascia adjacent the distal end, the second locking element configured to mate with the first locking element;
d) a release member mounted to the mounting bracket adjacent the first locking element, the release member movable between a locked position wherein the release member is clear of the second locking element, and a release position wherein the release member bears against the second locking element sufficiently to disengage the second locking element from the first locking element.

2. The fascia and mounting bracket combination of claim 1 wherein the release member comprises a screw.

3. The fascia and mounting bracket combination of claim 1 wherein the bracket has an extended arm portion with a first mounting element positioned on an end thereof, the fascia having a second mounting element adjacent the face portion, the second mounting element configured to mate with the first mounting element, the arm of the bracket and the leg of the fascia being dimensioned such that the first and second mounting elements are coupled together when the first and second locking elements are mated together.

4. The fascia and mounting bracket combination of claim 3 wherein the second mounting element is positioned adjacent the proximal end of the leg.

5. The fascia and mounting bracket combination of claim 2 wherein the bracket has an extended arm portion with a first mounting element positioned on an end thereof, the fascia having a second mounting element adjacent the face portion, the second mounting element configured to mate with the first mounting element, the arm of the bracket and the leg of the fascia being dimensioned such that the first and second mounting elements are coupled together when the first and second locking elements are mated together.

6. The fascia and mounting bracket combination of claim 5 wherein the second mounting element is positioned adjacent the proximal end of the leg.

7. The fascia and mounting bracket combination of claim 1 further comprising a spring for biasing the second locking element towards the first locking element.
